(19) United States
(12) Patent Application Publication
(10) Pub. No.: US 2021/0016384 A1
(43) Pub. Date: Jan. 21, 2021

(54) METHODS AND SYSTEMS USING A MULTI-USAGE POWER SUPPLY FOR WELDING AND HEATING

(71) Applicant: Lincoln Global, Inc., Santa Fe Springs, CA (US)

(72) Inventors: Todd E. Kooken, University Heights, OH (US); William T. Matthews, Chesterland, OH (US); Mohamad Mrad, Dubai (AE)

(21) Appl. No.: 16/512,779

(22) Filed: Jul. 16, 2019

(51) Int. Cl. B23K 9/10

(52) U.S. Cl. CPC B23K 9/1075

(57) ABSTRACT

Systems and methods for welding, and more specifically to a power supply with the capability to power and control a welder and an associated workpiece heater. Exemplary systems and methods may further control a welder and associated heater according to feedback from the welder and/or heater.

### BACKGROUND OF THE INVENTION

Embodiments of the present invention generally relate to systems and methods for welding, and more specifically to a power supply with the capability to power and control a welder and an associated heater. Welding systems may rely on a heater system to heat the workpiece to be welded. Induction heaters are commonly used for pre-heating welding workpieces. These heaters operate as a stand-alone system, requiring their own controller, power source, monitoring, feedback, etc. Lack of coordination between the welder and heater can result in poor quality and inefficient welds.

In view of the foregoing problems and shortcomings of existing welding apparatus, the present application describes a system and method to overcome these shortcomings.

### SUMMARY

Embodiments of the present invention include systems, architectures, processes, and methods for enhancing various aspects of welding via the internet-of-things (interconnections, via the Internet, of computer devices embedded in objects, allowing data to be communicated between the objects).

According to an exemplary embodiment, a welding apparatus is provided. The welding apparatus comprising: a heater configured to heat a first workpiece; a welder configured to weld the first workpiece; a power supply configured to supply power to the heater and the welder; a controller in communication with the power supply unit, wherein the controller is configured to regulate power supplied form the power supply to the heat to achieve a temperature at the first workpiece and to the welder to weld the first workpiece.

The descriptions of the invention do not limit the words used in the claims in any way or the scope of the claims or invention. The words used in the claims have all of their full ordinary meanings

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention. It will be appreciated that illustrated element boundaries (e.g., boxes, groups of boxes, or other shapes) in the figures represent one embodiment of boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an exemplary embodiment of a robotic welding cell unit.

FIG. 2 illustrates an exemplary field welding and heating system.

FIG. 3 illustrates a schematic block diagram of an exemplary embodiment of welding system.

FIG. 4 illustrates a block diagram of an exemplary welding and heating system.

FIG. 5 illustrates another exemplary welding system.

FIG. 6 illustrates yet another exemplary welding system.

FIG. 7 illustrates yet another exemplary welding system.

FIG. 8 illustrates yet another exemplary welding system.

FIG. 9 illustrates an exemplary method of welding a workpiece.

FIG. 10 illustrates an exemplary temperature curve relating to heating a workpiece according to exemplary embodiments.

FIG. 11 illustrates an exemplary joint weld according to exemplary embodiments.

### DETAILED DESCRIPTION

The following includes definitions of exemplary terms used throughout the disclosure. Both singular and plural forms of all terms fall within each meaning:

“Component,” as used herein can be defined as a portion of hardware, a portion of software, or a combination thereof. A portion of hardware can include at least a processor and a portion of memory, wherein the memory includes an instruction to execute.

“Logic,” synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device and/or controller. Logic may also be fully embodied as software.

“Software”, as used herein, includes but is not limited to one or more computer readable and/or executable instructions that cause a computer, logic, or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

Embodiments of systems, architectures, processes, and methods for welding are disclosed herein. The examples and figures herein are illustrative only and are not meant to limit the subject invention, which is measured by the scope and spirit of the claims. The showings are for the purpose of illustrating exemplary embodiments of the subject invention only and not for the purpose of limiting same.

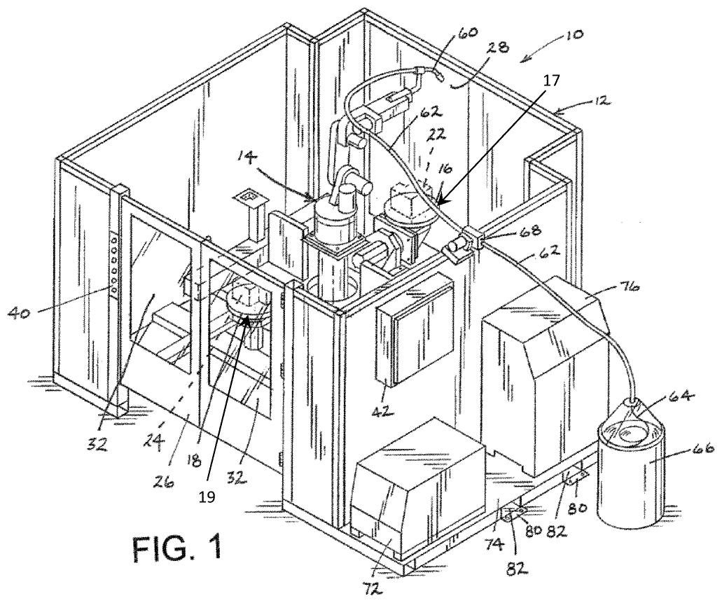

With reference to FIG. 1, a drawing of an exemplary welding cell 10 generally includes a frame 12, a robot 14 disposed within the frame 12, and first and/or second welding tables 16 and 18, respectively, also disposed within the frame 12. Welding tables 16, 18 each include integrated heaters 17, 19 (e.g., heating coils or wires) for heating workpieces 22 and 24 disposed on the respective welding tables 16, 18.

In the depicted embodiment, the frame 12 includes a plurality of side walls and doors to enclose the robot 14 and the welding tables 16 and 18. Even though a substantially rectangular configuration in plan view is shown, the frame 12, and the cell 10, can take numerous configurations. A front access door 26 mounts to the frame 12 to provide access to the interior of the frame 12. The front access door 26 can take a bi-fold configuration where the door includes two hinge sets: a first hinge set attaching the door 26 to the frame 12 and a second hinge set attaching one panel of the door to another panel. Nevertheless, the front access door 26 can take other configurations such as a sliding door or a swinging door. Similarly, a rear access door 28 also mounts to the frame 12. The rear access door 28 in the depicted embodiment also takes a bi-fold configuration; however, the rear access door can take other configurations such as those discussed with reference to the front access door 26. Windows 32 can be provided on either door (only depicted on front door 26). The windows can include a tinted safety screen, which is known in the art.

A control panel 40 is provided on the frame 12 adjacent the front door 26. Control knobs and/or switches provided on the control panel 40 communicate with controls housed in a controls enclosure 42 that is also mounted to the frame 12. The controls on the control panel 40 can be used to control operations performed in the cell 10 in a similar manner to controls used with known welding cell units.

In one embodiment, the robot 14 mounts on a pedestal that mounts on a support. In other embodiments, other automated movement devices may be used to control movement of the welding device. The robot 14 in the depicted embodiment is centered with respect to the welding tables 16 and 18 and includes eleven exemplary axes of movement. If desired, the pedestal can rotate with respect to the support similar to a turret. Accordingly, a drive mechanism, e.g. a motor and transmission (not shown), can be housed in the pedestal and/or the support for rotating the robot 14.

In one embodiment, a welding torch or gun 60 (or “welder”) of the welding device attaches to a distal end of the robot arm 14. The welding gun 60 can be similar to those that are known in the art and suitable for any type of welding, cutting, or similar processes, including, for example, shielded metal arc welding (SMAW), gas metal arc welding (GMAW, MIG), flux-cored arc welding (FCAW), gas tungsten arc welding (GTAW, TIG). A flexible tube or conduit 62 attaches to the welding gun 60, which can contain power, shielding gas, and/or consumable wire. For example, depending on the type of welding, consumable welding electrode wire 64, which can be stored in a container 66, may be delivered to the welding gun 60 through the conduit 62. A wire feeder 68 can be attached to the frame 12 to facilitate the delivery of welding wire 64 to the welding gun 60. Even though the robot 14 is shown mounted to a base or lower portion of the frame 12, if desired, the robot 14 can mount to an upper structure of the frame and depend downwardly into the cell 10.

In this embodiment, a power source 72 for the welding operation mounts to and rests on a platform 74 that is connected to and can be a part of the frame 12. The power source or power supply 72 supplies power to the welding gun 60 and the heaters 17, 19, as discussed in more detail below.

A robot controller 76, which controls the robot 14, also rests and mounts on the platform 74. The robot controller 76 typically accompanies the robot 14. A cell base can include various attachment points 80 and channels 82. Although shown as a stationary cell within a frame, other embodiments can include a robot and the associated welding equipment as part of a moving assembly line, a portable cell, etc.

In one embodiment, a welding/heater controller may also be included into the cell 10, for example, as a stand-alone device/component or as part of the controls enclosure 42, power source 72, robot controller 76, etc. A system controller may also comprise one or more of the controllers. Any or all of these controllers and control systems may be combined to various degrees into shared systems or enclosures.

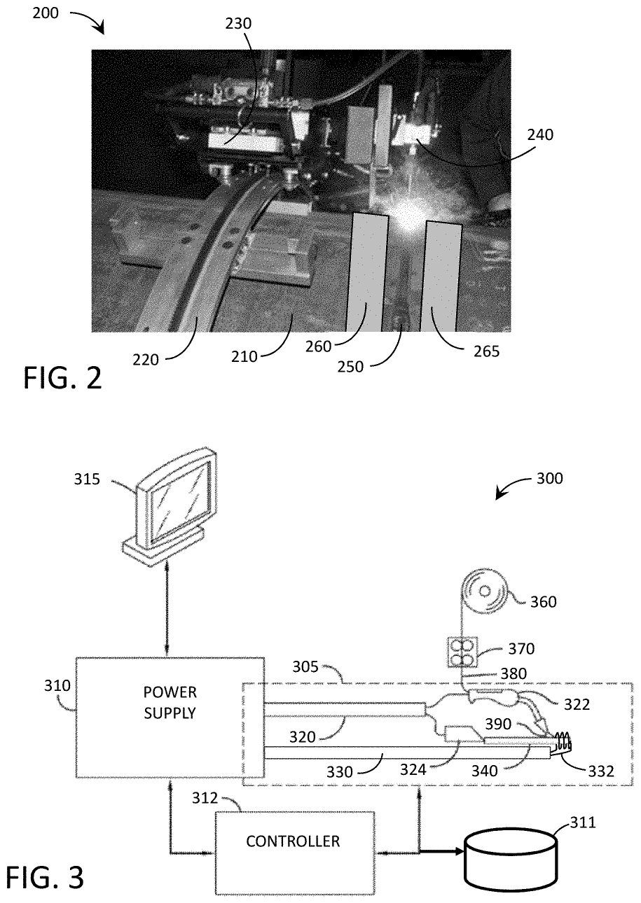

With reference to FIG. 2, a picture of an exemplary field welding and heating system 200 is shown for welding a pipe 210. System 200 includes a track 220 supporting a mechanized guide assembly 230 for controlling the position and speed of a welding torch 240 disposed proximate to a weld joint 250. In certain embodiments, field welding and heating system 200 may include a welding carriage to support the mechanized welding. Heaters 260, 265 (e.g., with integrated heating elements such as inductive/resistive coils or wire(s)), shown on each side of the weld joint 250, heat the pipe 210. In this embodiment, the heaters 260, 265 are shown as jackets encasing a heating element (not shown) surrounding the outer surface of the pipe 210. In other embodiments, various other types of heaters can be used.

FIG. 3 illustrates a schematic block diagram of an exemplary embodiment of welding system 300 showing power circuits 305. It is to be appreciated that welding system 300 can represent various welding system configurations, including automatic, semi-automatic, on-site, and/or manual welding systems with similar components. Welding system 300 includes power supply 310, controller 312, and display 315, shown operationally connected to power supply 310. Alternatively, display 315 may be an integral part of the power supply 310 or controller 312. In some embodiments, power supply 310, controller 312, and/or optional display 315 can be combined into one or more shared devices. For instance, controller 312 and/or display 315 can be incorporated into power supply 310, stand-alone components (as depicted), or a combination thereof. In certain embodiments, controller 312 and/or power circuits 305 may be configured to record weld data at a storage 311. In some embodiments, data from the power circuits and/or power supply 310 may be received at controller 312 and stored in raw or formatted form at storage 311.

Welding system 300 may further comprise welding cable 320, welder 322, workpiece connector 324, heater cable 330, heater 332 (e.g., including a heating coil or wire), spool of wire 360, wire feeder 370, welding wire 380, and workpiece 340.

In an embodiment utilizing welding wire as a consumable, wire 380 may be fed into welder 322 from spool 360 via wire feeder 370. In accordance with another embodiment of the present invention, welding system 300 does not include spool of wire 360, wire feeder 370, or wire 380 but, instead, includes a welding gun comprising a consumable electrode such as those used in, for example, stick welding. In accordance with various embodiments of the present invention, welder 322 may include at least one of a welding torch, a welding gun, and a welding consumable.

The welder circuit path runs from power supply 310 through welding cable 320 to welder 322, through workpiece 340 and/or to workpiece connector 324, and back through welding cable 320 to the power supply 310. During operation, electrical current runs through the welder circuit path as a voltage is applied to the terminals or electrodes of the welder circuit path. In accordance with an exemplary embodiment, welding cable 320 comprises a coaxial cable assembly. In accordance with another embodiment, welding cable 320 comprises a first cable length running from power supply 310 to welder 322, and a second cable length running from workpiece connector 324 to power supply 310.

The heater circuit path runs from power supply 310 through heater cable 330 to heater 332 and back through heater cable 330 to the power supply 310. During operation, electrical current runs through the heater circuit path as a voltage is applied to the terminals of the heater circuit path. Various types of heater cables 330 suitable for the application, (e.g., in accordance with the voltage, current level, frequency, temperature, etc.) may be used.

Welding system 300 includes controller 312. Controller 312 is configured to control the power circuits 305 (welder and heater circuit paths). The controller 312 may also control other aspects of the welding system 300, as described above. For example, controller 312 can interact with at least the power supply 310, a portion of welder circuit path, a portion of the heater circuit path, the wire feeder 370, or a combination thereof. In some embodiments, controller 312 can automatically adjust one or more elements of welding system 300 based on a welding sequence, wherein the welding sequence is utilized to configure welding system 300 (or an element thereof) without operator intervention in order to perform welding procedures with respective settings or configurations for each welding procedure. In some embodiments, the controller 312 may include or communicate with a welding job sequencer component.

In one embodiment, controller 312 is a computer operable to execute the disclosed methodologies and processes. In order to provide additional context for various aspects of the present invention, the following discussion is intended to provide a brief, general description of a suitable computing environment in which the various aspects of the present invention may be implemented. While the invention has been described above in the general context of computer-executable instructions that may run on one or more computers, those skilled in the art will recognize that the invention also may be implemented in combination with other program modules and/or as a combination of hardware and/or software. Generally, program modules include routines, programs, components, data structures, etc., that perform particular tasks.

Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices, for example, storage 311. For instance, a remote database, a local database, a cloud-computing platform, a cloud database, or a combination thereof can be utilized with controller 312.

Controller 312 can utilize various computing environments for implementing aspects of the invention, including, for example, a computer, wherein the computer includes a processing unit, a system memory and a system bus. The system bus couples system components including, but not limited to the system memory to the processing unit. The processing unit may be any of various commercially available processors. Dual microprocessors and other multi-processor architectures also can be employed as the processing unit. The system bus can be any of several types of bus structure including a memory bus or memory controller, a peripheral bus and a local bus using any of a variety of commercially available bus architectures. The system memory can include read only memory (ROM) and random access memory (RAM).

Controller 312 can include at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by controller 312. A number of program modules may be stored in the drives and RAM, including an operating system, one or more application programs, other program modules, and program data.

The controller 312 can operate in a networked environment using logical and/or physical connections to one or more remote computers. The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

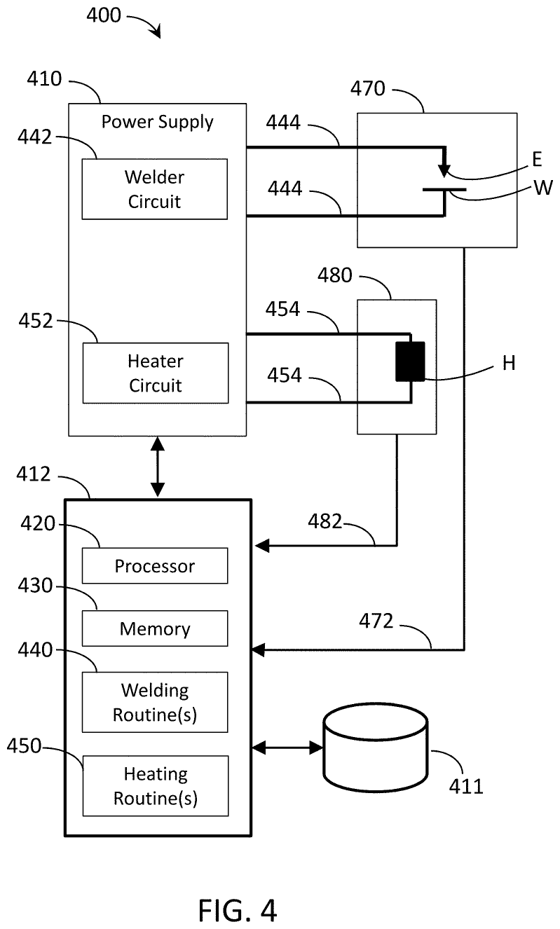

With reference to FIG. 4, a block diagram of an exemplary welding and heating system 400 is shown. In this embodiment, a weld controller 412 comprises a processor 420, memory 430, welding routine(s) 440, and/or heating routine(s) 450. In some embodiments, welding routine(s) 440 may comprise both heating and welding instructions or parameters for accomplishing a weld. In certain embodiments, controller 412 may be in communication with a storage 411. Storage 411 may store heat and weld data related to past welds (e.g. a weld record) and/or future welds (e.g. a weld plan). In some embodiments, controller 412 may receive welding routines 440 and/or heating routines 450 stored at storage 411. The welding and heating system 400 may include various additional components, logic, and software. By way of example and not limitation, a welding cell (such as, for example, cell 10 from FIG. 1) can include welding equipment (e.g., controller for a welder power source, welding device, wire feeder, welder power source, controller for a robot, among others) that can implement one or more routines or steps related to a particular welding process for a specific workpiece, e.g. welding routines 440, wherein a routine can include a respective setting, configuration, and/or position (e.g., path) for the welding equipment. It is appreciated that welding and heating system 400 may also be configured to include components associated with field welding and heating system 200, welding system 300, and/or other welding systems known in the art. Furthermore, the controller 412 can directly or indirectly control one or more welder power sources, parameters, welding schedules, robots, fixtures, feeders, etc. associated with one or more welding routines 440 or processes stored in a memory 430 and/or storage 411. An example of direct control is the setting of various welding parameters (voltage, current, waveform, etc.) associated with the welding power supply 410. An example of indirect control is the communication of welding position, path, speed, etc. to a robot controller or other peripheral device. The controller 412 may also execute welding sequences as described in US Pub. No. 2014/0042136 (Ser. No. 13/803,032), which is hereby incorporated by reference in its entirety. The hierarchy of the various controllers that may be associated with a welding cell 10 can be arranged in any suitable manner to communicate the appropriate commands to the desired devices. It is appreciated, that as used herein, a welding sequence may be used as a welding routine.

Power supply 410 is configured to provide welding power or waveforms via an output path/circuit or welding lines 444 for welding via a welder circuit 442. In this embodiment, one welding line 444 is connected to an exemplary welder 470 with a welding torch (comprising an electrode E), which may be any gun or torch of a welding device suitable for any of the exemplary welding processes mentioned above. In some embodiments, the welding torch may be attached to an automated or partially-automated movement device, such as a robot or mechanized guide assembly. In some embodiments, a semi-automatic welding process may be used. The other welding line 444 is connected to the workpiece W to complete the welder circuit, as is known in the art. As shown in FIG. 1, in one embodiment, the torch 470 may be mounted to a robot arm for positioning during welding. Controller 412 is configured to regulate welding power supplied at welding lines 444 via communication with a welder circuit 442. In some embodiments controller 412 may receive welder feedback information from welder feedback 472. Welder feedback information may comprise current, voltage, position, speed, etc. In certain embodiments, welder feedback information may be obtained from one or more sensors located in proximity to welder 470, electrode E, and/or workpiece W.

Power supply 410 may also be configured to regulate power to heating lines 454 via a heater circuit 452. In certain embodiments heater circuit 452 may be configured to perform modification or regulation of its input power before transmission to heater 480 via heating lines 454, including, for example converting to/from AC or DC power, modifying voltage, signal shape, frequency, amperage, etc. Heater circuit 452 may include various power components, including, for example, capacitors, bridge circuits, diodes, smoothing circuits, damping circuits, transformers, rectifiers, etc. Heating lines 454 may be connected to a heating element H associated with heater 480.

In certain embodiments, heating element H may comprise various types of devices capable of generating heat from an electrical input, including, for example, an inductive coil, a resistive wire, etc., which may be used to heat workpiece W. In some embodiments, heater 480 may comprise a heating jacket operable to conform to workpiece W. Heater 480 may be placed adjacent to the workpiece W to heat the workpiece or a portion of the workpiece. In some embodiments, the heater 480 is operable to provide heat (e.g. at workpiece W) to reach or maintain a specific temperature, for example, according to a welding routine 440 and/or heating routine 450 (including, for example, pre-heat, interpass, post-heat, etc.). In certain embodiments, additional heater systems comprising at least heating lines 454, heating element H, and heater 480, may be connected to the heater circuit 452. It will be appreciated that additional heater systems may be powered by power supply 410 to heat workpiece W and/or other workpieces (not shown).

In some embodiments controller 412 may receive heater feedback information from heater feedback 482. Heater feedback information may comprise temperature, current, voltage, etc. In certain embodiments, heater feedback information may be obtained from one or more sensors (e.g. temperature sensor(s)) located in proximity to heater 480. In some embodiments, welder and/or heater feedback information may be obtained from common sensors or measurement devices proximate to the electrode E and/or workpiece W. Controller 412 may be configured to control power supply 410 to perform welding and/or heating at workpiece W. In some embodiments, welding may be performed according to a welding routine 440 and heating may be performed according to a heating routine 450. In certain embodiments, heating and/or welding may be performed according to a welding sequence. In certain embodiments, welder circuit 442 and heater circuit 452 may be embodied in a combined circuit operable to regulate power at welder 470 and/or heater 480 via respective welding line(s) 444 and heating line(s) 454.

Power supply 410 may be used to perform various heating procedures associated with one or more welds. Generally, these heating procedures may include one or more heating phases associated with heating modes, including, for example, preheating, interpass heating, and post-weld heating. Heating procedures may vary according to material thickness, material type, and application of the finished workpiece. In some embodiments, accurate control of the heating or heat/temperature control involving one or more heating phases may be critical when dealing with exotic materials or materials having an extreme thickness (e.g. very thin or very thick).

In some embodiments, controller 412 may be configured to control power supply 410 to perform preheating at workpiece W. In some embodiments, controller 412 may perform preheating while in a preheat mode. Preheating involves heating the base metal of a workpiece, either in its entirety or just the region surrounding the weld location, to a specific desired temperature, called the preheat temperature, prior to welding. This temperature may be required to perform a quality weld, including, for example, to achieve proper penetration, achieve less excursion, or improve the strength or quality of a critical weld. For example, preheating may heat a workpiece from an initial temperature up to 350-400° F.

Heating may be continued during the welding process, but frequently the heat from welding is sufficient to maintain the desired temperature without a continuation of the external heat source. In many embodiments, the interpass temperature, defined as the base metal temperature between the first and last welding passes, cannot fall below the preheat temperature or is maintained at a different temperature. For example, the interpass temperature may be approximately 400-500° F.

Power supply 410 may regulate the preheat temperature, maintain interpass temperature, and/or perform post-weld heating or heat treatment (e.g., for annealing heat treatments). For example, a weld may have to be heated and/or cooled at a controlled rate to maintain weld quality.

In some embodiments, pre-heat, interpass, and/or post-heat temperatures are dictated by welding standards, such as, for example, ASME B31.1 for power piping, ASME B31.3 for process piping, etc. Welding standards may require post-weld heating be performed to relieve stress associated with the weld, for example, a two hour or an eight hour post-weld heat treatment (PWHT). In certain embodiments, post-weld heating may range from 700°-1400° F. Welding standards may further require the various heating phases to conform to predetermined thermal curves. For example, in some embodiments, a PWHT may heat a workpiece to a maximum temperature (e.g. 1400° F.) and gradually cool the workpiece by slowly modifying the temperature at a heater associated with the workpiece.

In certain embodiments, controller 412 may receive feedback information from welder feedback 482 and/or heater feedback 472. In certain embodiments, controller 412 may be configured to dynamically control welder 470 and/or heater 480 based on feedback information, for example, welder feedback 472 and heater feedback 482. For example, controller 412 may regulate power supplied to welder 470 to maintain a quality weld as identified by welder feedback 472. As another example, controller 412 may regulate power supplied to heater 480 to maintain a constant temperature identified by heater feedback 482. In certain embodiments, the controller 412 may wait until a target temperature is reached before proceeding from a heating step in a welding sequence to a welding step, based on heater feedback 482. In some embodiments, controller 412 may control heating during and/or after welding steps. It will be further appreciated that the controller 412 may utilize various combinations of feedback from welder feedback 472 and/or heater feedback 482 to dynamically regulate power to the welder 470 and/or heater 480. For example, controller 412 may stop power to welder 470 based on heater feedback 482 if such feedback indicates that the temperature at workpiece W has fallen below a threshold to maintain a stable or quality weld. In response to this feedback, controller 412 may activate heater 480 to heat workpiece W to a sufficient temperature, at which time controller 412 may activate welder 470 to continue a weld.

In complex applications, welding may require rigorous preheat/interpass temperature programs and/or post weld heat cycles. For example, in power generation and petrochemical applications, conformance to welding standards is critical in order to ensure safe and effective operation of welded materials. These applications may require more difficult weld joint details (e.g. compound bevels, thicker walls, etc.) resulting in more difficult machining, fit up, and/or welding. With added complexity associated with these applications, manual and/or mechanized welding using a controller (e.g. controller 412) enables the welder to more precisely conform to the specifications required by appropriate standards. For example, in a power and process piping application, a qualification weld on ASTM 335 Grade P22 pipe measuring 18″ (46 cm)×0.939″ (24 mm) wall is associated with strict heating and welding requirements. ASTM A335 Grade P11 and Grade P22 are common base materials used in power and process piping applications at elevated temperatures for creep-resistance in refineries. Fabricating piping systems using SA-335 Grade P11 or P22 power piping material is governed by Power Piping Code (ASME B31.1). This code covers external piping for power boilers and high temperature, high pressure water boilers in which steam or vapor is generated at a pressure of more than 15 psig (100 kPa gage) and high temperature water is generated as pressures exceeding 160 psig (1103 kPa gage) and/or temperatures exceeding 250° F. (120° C.). These operating pressures and temperatures dictate the use of thick wall pipe in most power generation or petrochemical applications. During power station and refinery shutdowns, repair work is often required because of creep damage in the Type IV zone of a welded joint, particularly in power plants. Over its lifetime, a welded joint may experience several thermal cycles as a result of repairs or new fabrication in close proximity.

An exemplary multi-pass welding procedure in accordance with the above applications is shown in Table 1.

TABLE 1
PROCEDURES

| | | Polar- | | | | | | | | | Polar- | | | | | | |
|---|---|---|---|---|---|---|---|---|---|---|---|---|---|---|---|---|---|
| Pass | Pass | ity | Volts | Amps | Time | Length | TS | [symbol] | Pass | Pass | ity | Volts | Amps | Time | Length | TS | [symbol] |
| No. | disc. | elec. | (V) | (I) | (min) | (inch) | in/min) | (KJ/in) | No. | disc. | elec. | (V) | (I) | (min) | (inch) | (in/min) | (KJ/in) |
| 1 | Root | − | 10 | 90 | 8.13 | 28.3 | 3.5 | 16 | 1 | Root | − | 10 | 90 | 8.13 | 28.3 | 3.5 | 16 |
| 2 | Hot | − | 10 | 130 | 9.44 | 28.3 | 3.0 | 26 | 2 | Hot | − | 10 | 130 | 9.44 | 28.3 | 3.0 | 26 |
| 3 | Fill | − | 10 | 135 | 9.96 | 28.3 | 2.8 | 29 | 3 | Fill | − | 10 | 135 | 9.96 | 28.3 | 2.8 | 29 |
| 4 | Fill | + | 23.9 | 201 | 3.50 | 28.3 | 8.1 | 36 | 4 | Fill | + | 23.5 | 190 | 3.5 | 28.3 | 8.1 | 33 |
| 5 | Fill | + | 24.4 | 200 | 3.17 | 28.3 | 8.9 | 33 | 5 | Fill | + | 23.2 | 185 | 3.22 | 28.3 | 8.8 | 29 |
| 6 | Fill | + | 24.5 | 192 | 3.40 | 28.3 | [symbol] | 34 | 6 | Fill | + | 23 | 196 | 3.12 | 28.3 | 9.1 | 30 |
| 7 | Fill | + | 25.2 | 215 | 3.00 | 28.3 | 9.4 | 34 | 7 | Fill | + | [symbol] | 214 | 3.22 | 28.3 | 8.8 | 35 |
| 8 | Fill | + | 25 | 217 | 3.00 | 28.3 | 9.4 | 35 | 8 | Fill | + | 23.7 | 215 | 3.05 | 28.3 | 9.3 | 33 |
| 9 | Fill | + | 24.9 | 218 | 3.50 | 28.3 | [symbol] | 40 | 9 | Fill | + | 24 | 209 | [symbol] | 28.3 | 8.4 | 36 |
| 10 | Fill | + | 24.6 | 215 | 3.30 | 28.3 | [symbol] | 37 | 10 | Fill | + | 24.2 | 204 | 3.5 | 28.3 | 8.1 | 37 |
| 11 | Fill | + | 24 | 197 | 3.87 | 28.3 | 7.3 | 39 | 11 | Fill | + | 24.2 | 189 | 4.12 | 28.3 | [symbol] | 40 |
| 12 | Fill | + | 24.5 | 180 | 3.35 | 28.3 | 8.4 | 31 | 12 | Fill | + | 23.9 | 187 | 4.27 | 28.3 | [symbol] | 40 |
| 13 | Fill | + | 24.2 | 195 | 4.00 | 28.3 | 7.1 | 40 | 13 | Fill | + | 24.1 | 187 | 4.12 | 28.3 | 6.87 | 39 |
| 14 | Fill | + | 24 | 199 | 4.30 | 28.3 | 6.6 | 44 | 14 | Fill | + | 24.3 | 184 | 4.23 | 28.3 | 6.69 | 40 |
| 15 | Fill | + | 24 | 203 | 4.05 | 28.3 | 7.0 | 42 | 15 | Fill | + | 24.3 | 188 | 4.37 | 28.3 | 6.48 | 42 |
| 16 | Fill | + | 24.1 | 193 | 4.00 | 28.3 | 7.1 | 39 | 16 | Fill | + | 24 | 189 | 4.27 | 28.3 | 6.63 | 41 |
| 17 | Cap | + | 24.3 | 187 | 4.50 | 28.3 | 6.3 | 43 | 17 | Cap | + | 24 | 189 | 3.88 | 28.3 | 7.29 | 37 |
| 18 | Cap | + | 24.2 | 185 | 4.27 | 28.3 | 6.6 | 41 | 18 | Cap | + | 24.1 | 186 | 4.55 | 28.3 | 6.22 | 43 |
| 19 | Cap | + | 24.1 | 185 | 4.27 | 28.3 | 6.6 | 40 | 19 | Cap | + | 24 | 186 | 4.5 | 28.3 | 6.29 | 43 |

| TOTAL ARC | | | 87.0 | | | TOTAL ARC | | | 88.8 | | |
|---|---|---|---|---|---|---|---|---|---|---|---|
| TIME (min) | | | | | | TIME (min) | | | | | |
| AVERAGE | 23.2 | 197 | | 7.9 | 35 | AVERAGE | 22.4 | 192 | | 7.7 | 34 |
| (Fill-Cap) | | | | | | (Fill-Cap) | | | | | |

[symbol]

indicates data missing or illegible when filed

After completion of a weld procedure, for example, as listed in Table 1, certain PWHT procedures may be applied. For example, a multi-hour (e.g. 2-hour, 8-hour, etc.) immediate stress relief done directly after welding. Power generation and petrochemical applications typically involve higher temperatures so it is desired that resistance to creep and retention of tensile strength above minimum specification is desired.

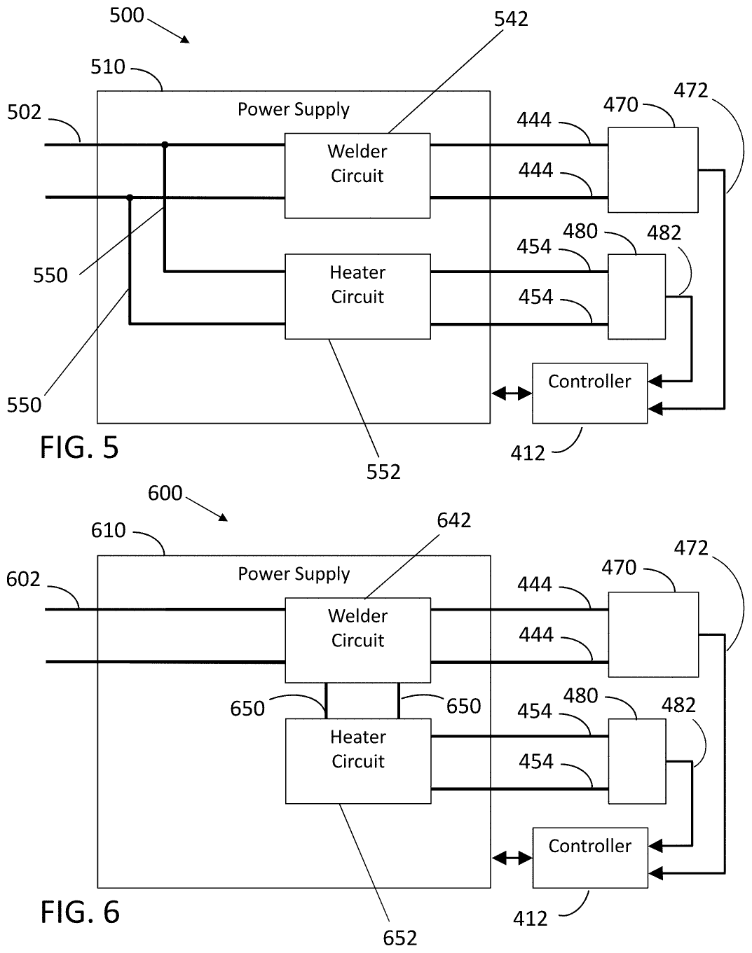

With reference to FIG. 5, an exemplary welding system 500 is shown. The welding system 500 comprises a power supply 510 a controller 412, a welder 470, and a heater 480. The power supply 510 may comprise a welder circuit 542 and a heater circuit 552. The welder circuit 542 is connected to welding lines 444 which may be connected to a welder 470. Heater circuit 552 is connected to heating lines 454 and a heater 480. The controller 412 may regulate power supplied by power supply 510 according to a weld routine and/or a heating routine. In some embodiments, the heater circuit 552 may redirect power directly from the power input 502 via heater circuit input lines 550.

With reference to FIG. 6, an exemplary welding system 600 is shown. The welding system 600 comprises a power supply 610 a controller 412, a welder 470, and a heater 480. The power supply 610 may comprise a welder circuit 642 and a heater circuit 652. The welder circuit is connected to welding lines 444 which may be connected to a welder 470. Heater circuit 652 is connected to heating lines 454 and a heater 480. The controller 412 may regulate power supplied by power supply 610 according to a weld routine and/or a heating routine. In some embodiments, the heater circuit 652 may receive power supplied by power input 602 directly from welder circuit 642 via heater circuit input lines 650. In certain embodiments, controller 412 may be configured to regulate power available from the welder circuit 642 via heater circuit input lines 650, for example, to turn heater 480 on or off.

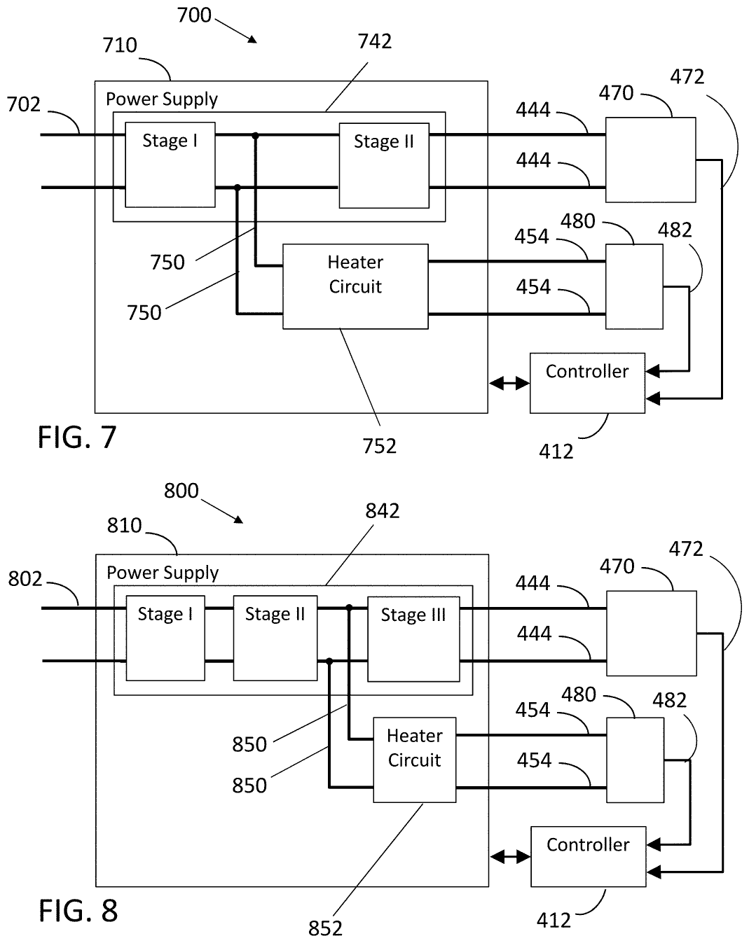

With reference to FIG. 7, an exemplary welding system 700 is shown. The welding system 700 comprises a power supply 710 a controller 412, a welder 470, and a heater 480. The power supply 710 may comprise a welder circuit 742 and a heater circuit 752. In one embodiment, the power supply 710 may be a dual stage power supply as disclosed in U.S. Pat. No. 5,991,169, which is incorporated herein in its entirety. The welder circuit 742 is connected to welding lines 444 which may be connected to a welder 470. Heater circuit 752 is connected to heating lines 454 and heater 480. The controller 412 may regulate power supplied by power supply 710 according to a weld routine and/or a heating routine. In some embodiments, the heater circuit 752 may receive power directly from welder circuit 742 from in between stage I and stage II of the power conversion process carried out by welder circuit 742, via heater circuit input lines 750. For example, heater circuit input lines 750 may receive power from a DC bus output by Stage I, as disclosed in the '169 patent. In certain embodiments heater circuit 752 may be configured to perform modification or regulation of its input power before transmission to heater 480 via heating lines 454, including, for example converting to/from AC or DC power, modifying voltage, signal shape, frequency, amperage, etc. Heater circuit 752 may include various power components, including, for example, capacitors, bridge circuits, diodes, smoothing circuits, damping circuits, transformers, rectifiers, etc. In certain embodiments, heater circuit 752 may receive input power at heater circuit input lines 750 from welder circuit 742 stage I in the form of 400V DC. In one embodiment, the heater circuit 752 may direct the power from welder circuit 742 to heater 480 without modification. In certain embodiments, heater 480 used in connection with welding system 700 comprises resistive wires to heat a workpiece.

With reference to FIG. 8, an exemplary welding system 800 is shown. The welding system 800 comprises a power supply 810 a controller 412, a welder 470, and a heater 480. The power supply 810 may comprise a welder circuit 842 and a heater circuit 852. In one embodiment, the power supply 810 may be a three stage power supply as disclosed in U.S. Pat. No. 8,785,816, which is incorporated herein in its entirety. The welder circuit 842 is connected to welding lines 444 which may be connected to a welder 470. Heater circuit 852 is connected to heating lines 454 and heater 480. The controller 412 may regulate power supplied by power supply 810 according to a weld routine and/or a heating routine. In some embodiments, the heater circuit 852 may receive power directly from welder circuit 842 in between stage II and stage III of the power conversion process carried out by welder circuit 842 via heater circuit input lines 850. For example, heater circuit input lines 850 may receive power from a DC bus output by Stage II, as disclosed in the '816 patent.

Heater circuit 852 may be configured to perform modification or regulation of its input power before transmission to heater 480 via heating lines 454, including, for example converting to/from AC or DC power, modifying voltage, signal shape, frequency, amperage, etc. Heater circuit 852 may include various power components, including, for example, capacitors, bridge circuits, diodes, smoothing circuits, damping circuits, transformers, rectifiers, etc. In some embodiments, heater circuit 852 may receive input power at heater circuit input lines 850 from welder circuit 842 stage II in the form of 100V DC. In one embodiment, the heater circuit 852 may direct the power from welder circuit 842 to heater 480 without modification. In certain embodiments, heater 480 used in connection with welding system 800 comprises inductive coils to heat a workpiece. In some embodiments, the power received by heater 480 is 40 kHz high frequency.

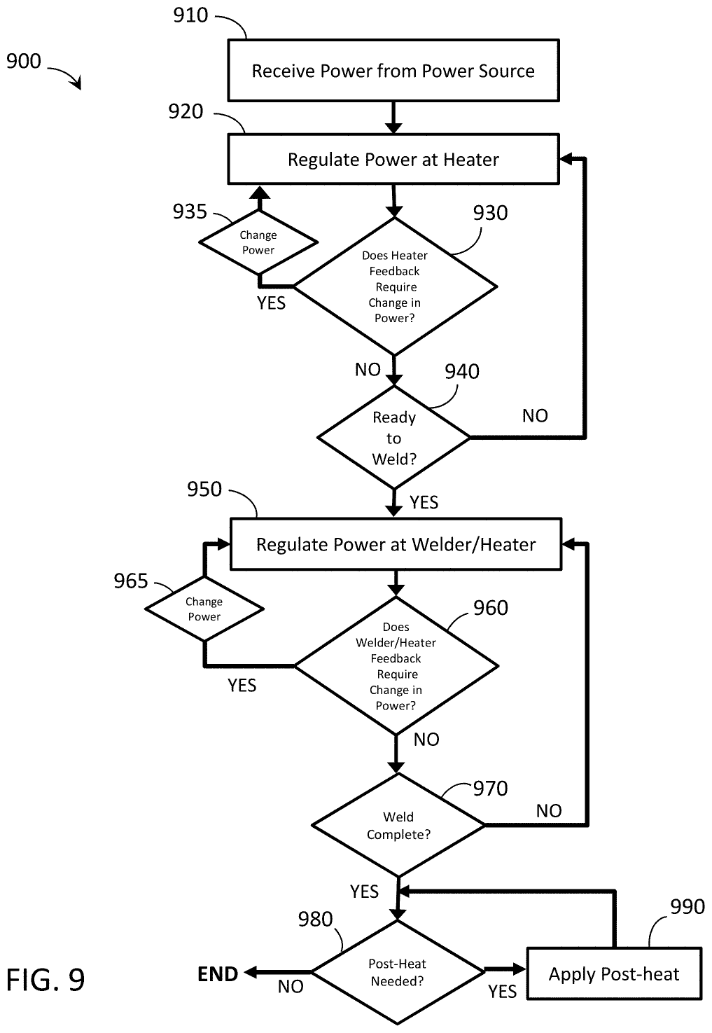

With reference to FIG. 9, an exemplary method 900 of welding a workpiece is provided. The following block diagram is an exemplary methodology associated with welding and heating a workpiece, including in accordance with the systems described above. The exemplary methodologies may be carried out in logic, software, hardware, or combinations thereof. In addition, although the methods are presented in an order, the blocks may be performed in different orders, series, and/or parallel. Further, additional steps or fewer steps may be used.

At step 910, power is received from a power source. A power source may be any power supply, for example, power supply 310, power supply 410, power supply 510, power supply 610, power supply 710, or power supply 810. At step 920, power may be regulated in a heater and/or heater circuit to achieve a temperature at a workpiece. At step 930, it is determined if the heater feedback requires a change in power. If it is determined that change in power is needed, power settings at the heater are changed at step 935 and the method 900 returns to step 920 to regulate power in the heater. At step 940, it is determined if the workpiece is ready to weld (e.g. a target pre-heat temperature at the workpiece has been reached). If the workpiece is not ready to weld, the method 900 returns to step 920 to regulate power at the heater. If it is determined that the workpiece is ready to weld, power is regulated at the welder at step 950 which may weld the workpiece. Power may also be regulated at the heater at step 950 in order to maintain an interpass temperature sufficient to continue a weld. It will be appreciated that heater control and feedback may continue in parallel with welding and welding feedback. At step 960, it is determined if the welder and/or heater feedback requires a change in power. If a change is power is required, power settings at the heater and/or welder are changed at step 965 and the method 900 returns to step 950 to regulate power at the welder and/or heater to maintain the desired temperature (which may include, for example, changes in welding waveforms). If the feedback does not indicate that a change in power is needed, the method proceeds to step 970, where it is determined if the weld is complete (e.g. based on a weld sequence). In certain embodiments, step 970 may receive feedback from the heater and the welder. If the weld is not complete, the method returns to step 950 to regulate power at the welder and/or heater (e.g. to maintain or return to an interpass temperature). If the weld is complete, at step 980 it is determined if post-heat procedures (e.g. annealing heat treatments) are needed. If no post-heat procedures are needed, the method 900 ends. If it is determined that post-heat procedures are needed, at step 990 post-heat (e.g. post weld heat treatment (PWHT)) is applied to the workpiece. Application of post-heat procedures may include at similar 920/930/935 loop until the post-heat procedures are complete. After post-heat procedures have been applied, the method returns to step 980 to determine if additional post-heat procedures are needed. The method 900 ends when it is determined that no more post-heat procedures are needed.

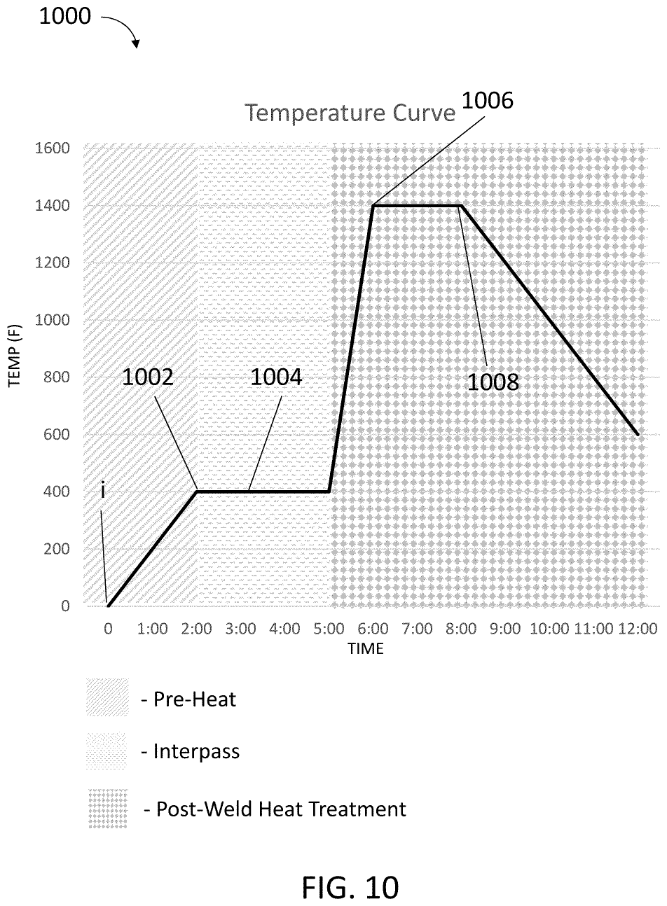

With reference to FIG. 10, an exemplary temperature curve 1000 relating to heating a workpiece according to exemplary embodiments is provided. A workpiece starts at an initial temperature i. It will be appreciated that the initial temperature of the workpiece may vary according to an application, for example, the ambient conditions, the location of the workpiece, the type of material, thickness of material, etc. While initial temperature i may vary, it always represents a first temperature reading at the workpiece at the beginning of the pre-heat phase. The pre-heat phase can heat the workpiece from the initial temperature i to a desired preheat temperature 1002. In one embodiment, as shown in FIG. 10, a heater may gradually heat the workpiece to a preheat temperature, for example, between 350-400° F. over a period of two hours. After the desired preheat temperature 1002 has been achieved, welding may begin at an interpass temperature 1004, which may be the same or different than the preheat temperature 1002. In one embodiment, as shown in in FIG. 10, interpass temperature 1004 may be between 400-500° F. In may embodiments, the interpass temperature 1004 remains substantially constant throughout the duration of the weld. Once the weld is complete, a post-weld heat treatment (PWHT) may be applied. A PWHT may include heating the workpiece to a PWHT temperature 1006, including in accordance with a time-based curve. For example, the PWHT temperature 1006 may be between 700-1400° F. In one embodiment, as shown in FIG. 10, the maximum PWHT is 1400° F. and is achieved approximately one hour after completion of the weld. In some embodiments, the PWHT may continue to heat the workpiece at the PWHT temperature 1006 for a period of 2-8 hours. The heat treatment process may then begin a cool-down at PWHT cool-down 1008. Starting PWHT cool-down 1008 may be a desired temperature and/or time that a cool-down procedure should begin. At PWHT cool-down 1008, the temperature of the workpiece is gradually decreased to a final temperature. In some embodiments, the various heating phases or modes may be controlled by a controller (e.g. controller 412) wherein the controller may utilize feedback information to automatically transition from one heating phase to another. It will be appreciated that the times and temperatures given above with reference to FIG. 10 are used by way of example only, and should not be construed as limiting.

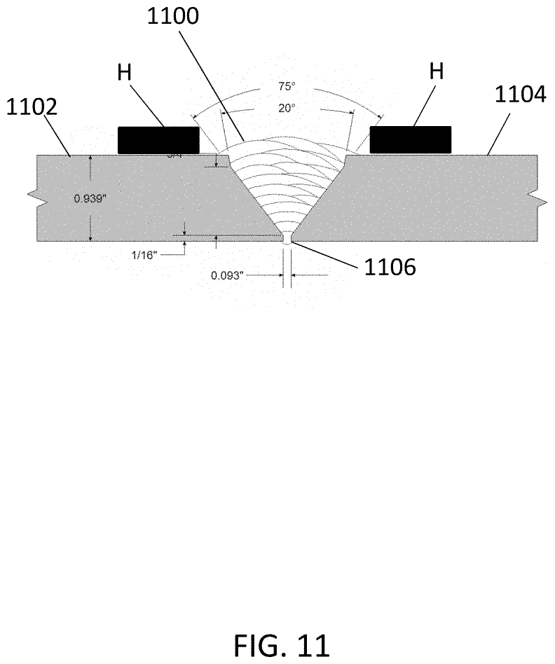

With reference to FIG. 11, an exemplary weld joint 1100 according to an exemplary embodiment is shown. A first workpiece section 1102 is joined to a second workpiece section 1104 at joint 1106. Heater(s) H may be placed in proximity to the weld joint 1100. Heater(s) H may include one or more sensors for determining temperature or other feedback information. Exemplary weld joints, as utilized herein, may have a 75° included angle, 1/16″ (1.66 mm) land and are spaced with a root gap of 3/32″ (2.4 mm) for Gas Tungsten Arc Welding (GTAW) root welding with a welding consumable, for example, Metrode ER90S-B3. To reduce filler metal on thick wall welds (e.g. greater than ¾″ (19 mm)) compound bevels are typical.

While the embodiments discussed herein have been related to the systems and methods discussed above, these embodiments are intended to be exemplary and are not intended to limit the applicability of these embodiments to only those discussions set forth herein. The control systems and methodologies discussed herein may be equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those of skill in the art.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

We claim:

1. A welding apparatus comprising:
a heater configured to heat a first workpiece;
a welder configured to weld the first workpiece;
a power supply configured to supply power to the heater and the welder; and,
a controller in communication with the power supply, wherein the controller is configured to regulate power supplied from the power supply to the heater to achieve a temperature at the first workpiece and to the welder to weld the first workpiece.

2. The welding apparatus of claim 1, wherein the power supply further comprises a welder circuit and a heater circuit, wherein the welder circuit supplies power to the welder and to the heater circuit.

3. The welding apparatus of claim 2, wherein the welder circuit comprises a dual stage power supply, wherein the first stage supplies power to the heater circuit.

4. The welding apparatus of claim 2, wherein the welder circuit comprises a three stage power supply, wherein the second stage supplies power to heater circuit.

5. The welding apparatus of claim 1, wherein the controller is further configured to receive feedback from the welder and regulate power supplied to the welder based on the feedback.

6. The welding apparatus of claim 1, wherein the controller is further configured to receive feedback from the heater and regulate power supplied to the heater based on the feedback.

7. The welding apparatus of claim 1, wherein the controller is further configured to receive feedback from the heater and regulate power supplied to the welder based on the feedback.

8. The welding apparatus of claim 1, wherein the controller is configured to regulate power at the welder based on a welding routine.

9. The welding apparatus of claim 1, wherein the controller is configured to regulate power at the heater based on a welding routine.

10. A method of welding a workpiece, the method comprising:
receiving power from a power source;
regulating power received from the power source in a heater circuit to achieve a temperature at a workpiece; and,
regulating power received from the power source in a welder circuit to weld the workpiece.

11. The method according to claim 10, wherein regulating power in the heater circuit is performed according to a welding routine.

12. The method according to claim 10, wherein regulating power in the welder circuit is performed according to a welding routine.

13. The method according to claim 10, wherein the welder circuit supplies power to the welder and to the heater circuit.

14. The method according to claim 10, wherein the welder circuit comprises a dual stage power supply, wherein the first stage supplies power to the heater circuit.

15. The method according to claim 10, wherein the welder circuit comprises a three stage power supply, where the second stage supplies power to the heater circuit.

16. The method according to claim 10, further comprising receiving feedback from a welder and regulating power supplied to the welder based on the feedback.

17. The method according to claim 10, further comprising receiving feedback from a heater and regulating power supplied to the welder based on the feedback.

18. A method of welding a workpiece, the method comprising:
receiving power from a power source;
regulating power received from the power source in a heater circuit to achieve a temperature at a workpiece;
regulating power received from the power source in a welder circuit to weld the workpiece; and,
receiving feedback from the heater and the welder and regulating power to the welder based on the feedback.

19. The method according to claim 18, wherein the welder circuit comprises a dual stage power supply, wherein the first stage supplies power to the heater circuit.

20. The method according to claim 19, wherein the welder circuit comprises a three stage power supply, where the second stage supplies power to the heater circuit.
